(19) United States
(12) Patent Application Publication
(10) Pub. No.: US 2006/0188404 A1
(43) Pub. Date: Aug. 24, 2006

(54) Method and article for sealing a microplate

(76) Inventor: Douglas T. Gjerde, Saratoga, CA (US)

Correspondence Address: Douglas T. Gjerde;PhyNexus, Inc., ste A, 3670 Charter Park Dr., San Jose, CA, 95136, US

(21) Appl. No.: 11/357,764

(22) Filed: Feb. 17, 2006

Related U.S. Application Data
(60) Provisional application No. 60/655,464, filed on Feb. 22, 2005.

(51) Int. Cl. B01J 3/00

(52) U.S. Cl. 422/99

(57) ABSTRACT

The invention provides cover seals for covering microplates in a manner which attenuates evaporation of liquid from the microplate, while allowing pipette tip access to wells of the microplate.

### CROSS REFERENCE TO RELATED APPLICATIONS

This application claims priority to and benefit of U.S. Provisional Patent Application 60/655,464 filed Feb. 22, 2005 the disclosure of which is incorporated herein by reference in its entirety for all purposes. This application claims the benefit of U.S. patent application Ser. No. 10/620,155, filed Jul. 14, 2003; U.S. patent application Ser. No. 10/754,352, filed Jan. 8, 2004; U.S. patent application Ser. No. 10/921,010 filed Aug. 17, 2004; U.S. patent application Ser. No. 10/434,713, filed May 8, 2003; and U.S. patent application Ser. No. 10/733,534, filed Dec. 10, 2003.

### FIELD OF THE INVENTION

This invention relates to cover seals for covering microplates in a manner which attenuates evaporation of liquid from the microplate, while allowing pipette tip access to wells of the microplate.

### BACKGROUND OF THE INVENTION

In the chemical processing and testing of liquid samples, disposable plastic trays are often utilized having a plurality of open top wells, the plurality of wells allowing a single test tray to hold a multitude of specimens. Such test trays (i.e., “microplates”) ordinarily comprise a lightweight, integral molded plastic disposable unit having a large number of open wells, each of which are configured to receive a sample of the analytes to be tested and analyzed. For several reasons, it has been found preferable to provide the open top face of such microplates with a covering. One key reason for doing so is the necessity of preventing the evaporation of the fluids contained in the wells to preserve the integrity and concentration of each sample. Such covers also serve to prevent the inadvertent spillage of each well's contents during transport from one location to another, prevent cross contamination between individual wells, and provide a generally controlled environment under which the testing and analysis of the fluids contained in the wells may be carried out. The covers which are normally applied to such microplates generally comprise a thin, flaccid, pressure sensitive adhesive film (i.e., a “sealing tape” or “cover seal”) configured to be applied to the top face of the microplate. In use, the film is applied to the top, open face of the microplate with its adhesive backing facing the top face of the microplate, such that the film is positioned over each of the individual open top wells. A microplate sealing tape applicator is then typically used to ensure uniform adhesion to the plate.

In certain applications, it is desirable to be able to insert a liquid handling device such as a pipette tip into a film-sealed microplate well, and then withdraw the liquid handling device from the well, without removing the film from the microplate. For example, high throughput sample preparation using pipette tip separation columns, as described in U.S. Patent Application Nos. US2004/0072375, US2004/0142488, and US2005/0019951, typically involves the insertion of pipette tip columns into microplate wells, manipulation of liquid in the wells, and withdrawal of the tip column from the well. If a standard sealing tape is used, insertion of the pipette tip column into the well will result in a hole in the tape, which will allow evaporation to occur. Thus, the availability of cover seals for covering microplates in a manner which attenuates evaporation of liquid from the microplate, while allowing pipette tip access to wells of the microplate, would be highly desirable, particularly in the case of liquid samples that are small and/or volatile, and hence particularly susceptible to the effects of evaporation.

### BRIEF DESCRIPTION OF THE FIGURES

FIG. 1 depicts a microplate and an embodiment of a cover seal.

FIG. 2 depicts an embodiment of a cover seal.

FIG. 3 depicts an embodiment of a cover seal.

### DESCRIPTION OF SPECIFIC EMBODIMENTS OF THE INVENTION

Before describing the present invention in detail, it is to be understood that this invention is not limited to specific embodiments described herein. It is also to be understood that the terminology used herein for the purpose of describing particular embodiments is not intended to be limiting. As used in this specification and the appended claims, the singular forms “a”, “an” and “the” include plural referents unless the context clearly dictates otherwise.

Unless defined otherwise, all technical and scientific terms used herein have the same meaning as commonly understood by one of ordinary skill in the art to which the invention pertains. Although any methods and materials similar or equivalent to those described herein can be used in the practice or testing of the present invention, specific examples of appropriate materials and methods are described herein.

Before describing several exemplary embodiments of the invention, it is to be understood that the invention is not limited to the details of construction or process steps set forth in the following description. The invention is capable of other embodiments and of being practiced or being carried out in various ways.

This invention relates to cover seals for covering microplates, or portions of microplates in a manner which attenuates evaporation of liquid from the microplate, while allowing a liquid handling device to access to wells of the microplate for the withdrawal of liquid. The term “liquid handling device” is defined herein as a pipette tip or a fused silica capillary. The liquid handling device is attached to a pumping means such that the attached pipette tip or fused silica capillary can aspirate and dispense liquids or gasses.

In operation, the cover seal or film is operatively affixed to a microplate, such that the slits are positioned over corresponding wells on a microplate, and a liquid handling device is inserted through the slit for transfer of liquid to and/or from the corresponding well. The term “pipette tip” refers to conventional pipette tips, modified pipette tips (such as the pipette tip columns described in U.S. Patent Application Nos. US2004/0072375A1, US2004/0142488, and US2005/0019951), and non-conventional pipette tips sharing similar function and/or structure with conventional pipette tip. Fused silica capillaries can be used for handling very small sample sizes and open tube capillary columns provide a means for purifying an analyte from a sample solution. The capillary is connected to a pump, e.g., a syringe pump for aspirating and dispensing liquids. Typically the connection between the capillary and the pump is a frictional fitting such as a luer adaptor, O-ring, taper. The use of open tube capillaries is described in more detail in U.S. Patent Applications US2004/0126890 and US2004/0223880 which are incorporated by reference herein.

In certain embodiments of the invention, the microplates used with cover seal are of standard size length and width (approximately 8.5 cm by 12.5 cm). However the microplate height and number of wells can vary. The number of wells on the microplate can be 6, 12, 24, 48, 96, 384, 1536, or more. The cover seal or film of the instant invention can cover the entire microplate or portions thereof. For example, the film can cover 8 wells, 12 wells, or 48 wells of a standard 96-well microplate.

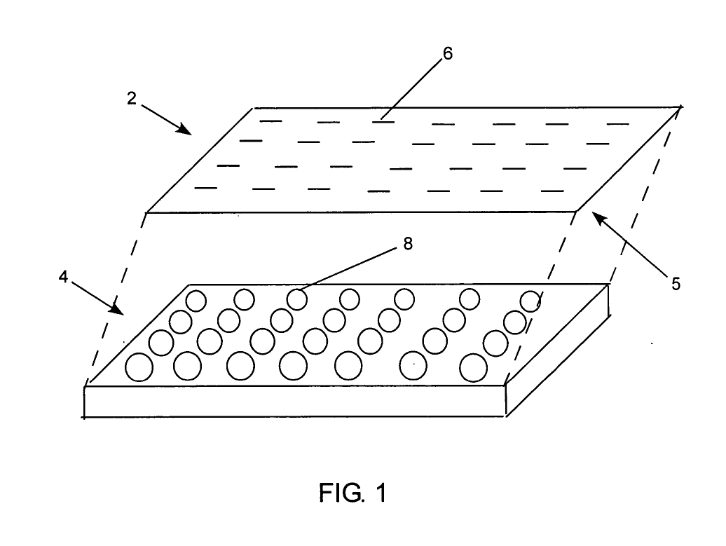

An exemplary embodiment of the invention is depicted in FIG. 1. The cover seal 2 includes a plurality of slits 6, wherein the position of each slit corresponds to the position of a well 8 on a microplate 4. The lower face 5 of the cover is coated with an adhesive for attachment to a corresponding microplate.

The film should have sufficient pliability that the output end of the liquid handling device can penetrate the slit. The slit must be able to accommodate the insertion of a liquid handling device of given diameter. For example, since many pipette tips are frustoconical in shape, tapering from a relatively small diameter at the output end to an ever increasing diameter toward the point of attachment to a pipettor, the diameter that must be accommodated will vary depending upon the depth to which the pipette tip is inserted into the well. In some embodiments of the invention, it is important that the pipette tip be inserted such that the output end is near the bottom of the corresponding well, i.e., for withdrawing substantially all of the liquid present in the well. In other embodiments, less than full insertion of the pipette tip is permitted, for example, when not all of the liquid will be withdrawn, or when liquid is being deposited from the pipette tip into the well.

The diameter that must be accommodated will also depend upon the size of the pipette tip. For example, a 1000 μL pipette tip is generally of greater diameter than a 200 μL pipette tip when inserted through the slit to the same extent. The effective pipette tip diameter that can be accommodated is a function of the size/length of the slit, the nature of the slit, and the pliability of the film. The term “effective diameter” refers to the maximum diameter of the liquid handling device that actually penetrates the slit. In general, the larger the slit and the more pliable the film, the greater the effective diameter that can be accommodated by the slit. The nature of the slit can also have an effect on its penetrability, e.g., a single straight slit vs. a U-cut vs. a cross-cut, as described elsewhere herein.

Various embodiments of the invention include slits able to accommodate a liquid handling device having an effective diameter of 0.1 mm, 0.2 mm, 0.3 mm, 0.4 mm, 0.5 mm, 0.6 mm, 0.7 mm, 0.8 mm, 0.9 mm, 1 mm, 2mm, 3 mm, 4 mm, 5 mm, 6 mm, 7 mm, 8 mm, 9 mm, 10 mm, or greater. The liquid handling device effective diameter accommodated by a slit can also be characterized in terms of the corresponding microplate well. Thus, in various embodiments, the invention includes slits able to accommodate a liquid handling device having an effective diameter of 0.1%, 0.5%, 1%, 2.5%, 5%, 7.5%, 10%, 20%, 30%, 40%, 50%, 60%, 70%, 80%, 90%, or more of a corresponding microplate well.

In certain embodiments of the invention, the film has sufficient memory such that after the liquid handling device is retracted, the slit substantially reverts to its original conformation prior to insertion of the liquid handling device. If the film has no memory, and the slit were to remain open after removal of the liquid handling device , the ability of the film to attenuate evaporation from the well would be diminished. By substantially reverting to its original conformation in a closed position, the seal is able to continue to minimize evaporative sample loss. The term “substantially reverts to its original conformation” indicates that the slit has reverted to a conformation that attenuates evaporative loss to substantially the same extent as in the original conformation, e.g., no more than a 100% greater rate of evaporation from the well, and preferably no more than a 90%, 80%, 70%, 60%, 50%, 30%, 20%, 10%, 5%, 2% or 1% rate of evaporation compared to the rate prior to penetration.

The rate of evaporation from a microplate can be determined by measuring loss of liquid from a microplate as a function of time under defined conditions. Loss of liquid is conveniently determined by monitoring the decrease in the weight of the microplate, as exemplified in the Examples section if this specification. The rate of evaporative loss can vary dramatically based on a number of different variables, such as the volatility of the liquid, the temperature, air circulation over the wells, the extent to which the wells are sealed, etc. Some of these variables are explored in the Examples.

Any of a wide variety of film types can be used in the practice of the invention, so long as the film has the necessary pliability and memory for the contemplated application of the cover seal, e.g., pipette tip diameter and extent of penetration. Other factors, such as the optical clarity of the film, the resilience of the film, chemical resistance, ease of application and removal, temperature resistance, and the tendency of the film to bind to itself or to the liquid handling device, can also be considered. The evaluation of a candidate film for use in the context of the present invention can be accomplished by one of skill in the art without undue experimentation. By way of example, the inventor has found that polyethylene terephthalate, about 60 microns thick, is a particularly suitable film material, such as that found in the sealing tape provided by Nunc Inc., Catalog No 236366 (Nalge Nunc International, Rochester, N.Y.). The film thickness can be in the range of 20 to 500 microns. Other potential film materials include polyester, polyolefin, advanced polyolefin, polyethylene terephthalate, polyvinylchrloride, polycarbonate, polypropylene, polystyrene, polyurethane, Delrin®, Kel-F (polychlorotrifluorethyene), PEEK®, acetal, acrylonitrile butadiene styrene, polyvinylidene chloride, polyvinylidene fluoride, polytetrafluoroethylene, phenolic resin plastic, polyethylene, rayon and others.

In certain embodiments of the invention, the lower face of the film is coated with an adhesive for attachment to a corresponding microplate. The term “adhesive” is defined herein as a substance that unites or bonds surfaces together. Using this definition, the adhesive is not limited to sticky substances such as glue. The film can be comprised of a substance that permits it to be operatively affixed to the microplate by other means, such as van der Waals forces. In certain embodiments of the invention, the film is comprised of multiple layers.

A particularly suitable adhesive is silicone, such as is found in the sealing tape provided by Nunc Inc., Catalog No 236366. Other potential adhesives include, but are not limited to cellulose, acrylate, pressure sensitive acrylate, acrylic, and pressure sensitive silicone. In some embodiments of the invention, when a cover seal of the invention is operatively affixed to a corresponding well plate, evaporation of a liquid from a well on the plate is substantially attenuated, e.g., attenuated to a rate that is less than 50% of the evaporation rate from the corresponding well plate when uncovered, and preferably to a rate that is less than 30%, 20%, 10%, 5%, 2%, or 1% of the evaporation rate from the corresponding well plate when uncovered.

The issue of binding must be considered when selecting an appropriate cover seal material and slit architecture. Binding occurs as a result of friction between the liquid handling device and the cover seal. Possible consequences of binding include pulling the pipette tip off the pipettor, disrupting the connection between the capillary and the pump, disrupting the seal between the cover seal and the plate, and lifting the plate off of a support. Binding can be a particular problem when multiple pipette tips are being used simultaneously, e.g., with a multichannel pipettor, an array of capillaries, or robotic liquid handling system.

The slit can take any of a wide variety of forms, so long as it is sufficiently penetrable by the liquid handling device of interest. For example, the slit can take the form of a straight line, as illustrated in FIG. 1. An advantage of this format is ease of production. A potential disadvantage is the straight line slit will not accommodate as wide of a pipette tip as some other formats. Another potential disadvantage is that in some cases a straight line slit can bind the liquid handling device. In the case of a pipette tip, binding could result in pulling the tip off the pipettor.

In various embodiments of the invention, the slit does not substantially bind a liquid handling device accommodated within the slit, having an effective diameter of 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, mm, 7 mm, 8 mm, 9 mm, 10 mm, or greater.

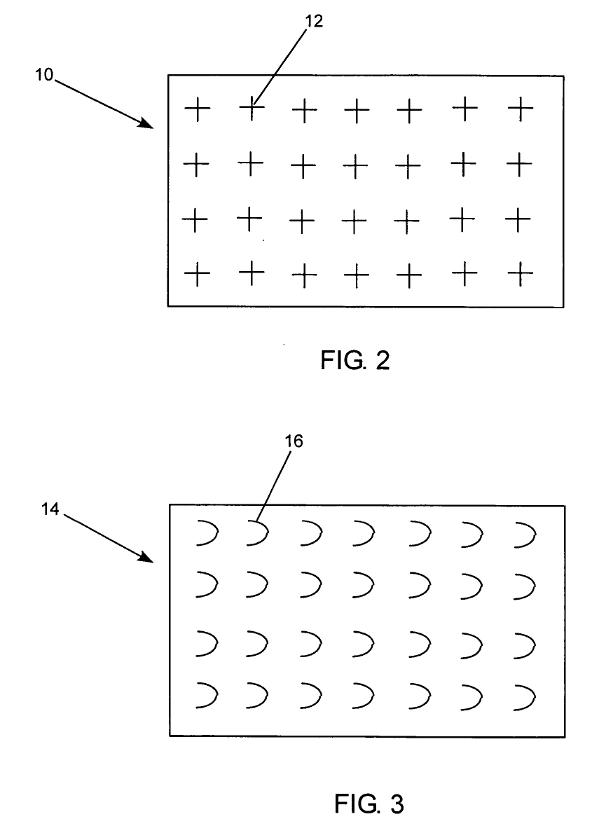

In some embodiments of the invention, the slit comprises a plurality of intersecting cuts. One example if this format is the cross-cut, as depicted in FIG. 2. FIG. 2 show a cover seal 10 having a plurality of cross-cut seals 12. The cross-cut is formed by two intersecting lines, forming the general shape of a cross or the letter “X.” The two intersecting lines can be perpendicular, as depicted in FIG. 3, or non-perpendicular. In some embodiments, more than two intersecting lines can be employed.

In some embodiments of the invention, the slit is a U-cut, as depicted in FIG. 3. FIG. 3 show a cover seal 14 having a plurality of U-cut slits 16. A U-cut is shaped generally like the letter “U,” which can be a section of a circle or oval. Penetration of a liquid handling device through the slit will result in the flap formed by the U-cut flipping downward toward the corresponding well. If a film with sufficient memory is used, withdrawal of the liquid handling device from the slit will result in the flap flipping back up to substantially its initial position, thereby effectively attenuating evaporation of liquid from the microplate.

In some embodiments, the slit is a full cut through the depth of the film. In others, the slit is not cut all the way through, but instead consists of a perforated line. This perforated line can be broken by pushing a liquid handling device through the slit.

The slits of the invention can be introduced into the film by any of a variety of methods known in the art, by cutting the film with a blade, or perforating with a perforating instrument.

All publications and patent applications mentioned in this specification are herein incorporated by reference to the same extent as if each individual publication or patent application was specifically and individually indicated to be incorporated by reference.

Having now generally described the invention, the same will be more readily understood through reference to the following examples, which are provided by way of illustration, and are not intended to be limiting of the present invention, unless so specified.

### EXAMPLES

The following preparations and examples are given to enable those skilled in the art to more clearly understand and practice the present invention. They should not be construed as limiting the scope of the invention, but merely as being illustrative and representative thereof.

### Example 1

### Preparation of a Microplate Cover Seal

The starting material was a sheet of polyester sealing tape with silicone adhesive, with external dimensions of 134×80 mm (Nunc Catalog No. 236366). 96 cross-cut slits were cut into the sealing tape in locations corresponding to the 96 wells of a corresponding microplate. Two perpendicular intersecting cuts were made with a sharp blade to result in perpendicular crosscuts as shown in FIG. 2.

### Example 2

### Evaporation Test at Room Temperature

10 μL of water was pipetted into each of the 96 wells of a standard 96 well microplate. A microplate cover seal as described in Example 1 was operatively affixed to the microplate, so that a slit was positioned over each well. A pipette was inserted and withdrawn from each slit, i.e., the slits were pierced. The microplate was maintained at 68° F. and the rate of evaporation was determined by monitoring the decrease in weight of the water as a function of time.

| | | Weighed mass | |
|---|---|---|---|
| Time (Min) | Loss | of water (g) | % Loss |
| 0 | 0 | 0.9319 | 0.0 |
| 30 | 0.0344 | 0.8975 | 3.7 |
| 60 | 0.0698 | 0.8621 | 7.5 |
| 90 | 0.1046 | 0.8273 | 11.2 |
| 120 | 0.1324 | 0.7995 | 14.2 |
| 150 | 0.1681 | 0.7638 | 18.0 |
| 180 | 0.2007 | 0.7312 | 21.5 |
| 270 | 0.3133 | 0.6186 | 33.6 |
| 300 | 0.3426 | 0.5893 | 36.8 |
| 330 | 0.3831 | 0.5488 | 41.1 |
| 390 | 0.4615 | 0.4704 | 49.5 |
| 450 | 0.5391 | 0.3928 | 57.8 |
| 510 | 0.6239 | 0.308 | 66.9 |

### Example 3

Evaporation Test at 4° C.

The evaporation test of example 2 was repeated at 4° C. A control plate having no cover was also monitored in parallel with the sealed plate.

| | Covered Plate | | | Uncovered Plate | | |
|---|---|---|---|---|---|---|
| | | Weighed | | | Weighed | |
| Time | | mass of | | | mass of | |
| (Min) | Loss | water (g) | % Loss | Loss | water (g) | % Loss |
| 0 | 0 | 0.9708 | 0.0 | 0 | 0.935 | |
| 30 | −0.005 | 0.9758 | −0.5 | 0.0192 | 0.9158 | 2.0 |
| 60 | −0.0127 | 0.9835 | −1.3 | 0.029 | 0.906 | 3.0 |
| 90 | −0.015 | 0.9858 | −1.5 | 0.0335 | 0.9015 | 3.5 |
| 120 | −0.0065 | 0.9773 | −0.7 | 0.0515 | 0.8835 | 5.3 |
| 150 | −0.0071 | 0.9779 | −0.7 | 0.0581 | 0.8769 | 6.0 |
| 180 | −0.0117 | 0.9825 | −1.2 | 0.0727 | 0.8623 | 7.5 |
| 210 | −0.0051 | 0.9759 | −0.5 | 0.0781 | 0.8569 | 8.1 |
| 240 | −0.0001 | 0.9709 | 0.0 | 0.1002 | 0.8348 | 10.4 |
| 270 | −0.0019 | 0.9727 | −0.2 | 0.1046 | 0.8304 | 10.8 |
| 300 | 0.0053 | 0.9655 | 0.5 | 0.1115 | 0.8235 | 11.5 |
| 330 | 0.0093 | 0.9615 | 1.0 | 0.1264 | 0.8086 | 13.1 |
| 360 | 0.0067 | 0.9641 | 0.7 | 0.1366 | 0.7984 | 14.1 |
| 390 | 0.022 | 0.9488 | 2.3 | 0.1609 | 0.7741 | 16.6 |
| 420 | 0.022 | 0.9488 | 2.3 | 0.1752 | 0.7598 | 18.1 |
| 450 | 0.0255 | 0.9453 | 2.6 | 0.1806 | 0.7544 | 18.7 |
| 480 | 0.0286 | 0.9422 | 2.9 | 0.2001 | 0.7349 | 20.7 |

### Example 4

### Evaporation Test at Room Temperature

The evaporation test of example 2 was repeated at room temperature. However, in this experiment, the slits were not pierced. A control plate having no cover was also monitored in parallel with the sealed plate.

| | Covered Plate | | | Uncovered Plate | | |
|---|---|---|---|---|---|---|
| | | Weighed | | | Weighed | |
| Time | | mass of | | | mass of | |
| (Min) | Loss | water (g) | % Loss | Loss | water (g) | % Loss |
| 0 | 0 | 0.9911 | 0.0 | 0 | 0.9523 | |
| 30 | 0.0992 | 0.8919 | 10.0 | 0.0754 | 0.8769 | 7.9 |
| 60 | 0.142 | 0.8491 | 14.3 | 0.1569 | 0.7954 | 16.5 |
| 90 | 0.1858 | 0.8053 | 18.7 | 0.2356 | 0.7167 | 24.7 |
| 120 | 0.224 | 0.7671 | 22.6 | 0.3096 | 0.6427 | 32.5 |
| 150 | 0.2613 | 0.7298 | 26.4 | 0.3836 | 0.5687 | 40.3 |
| 180 | 0.298 | 0.6931 | 30.1 | 0.4565 | 0.4958 | 47.9 |
| 210 | 0.3372 | 0.6539 | 34.0 | 0.5353 | 0.417 | 56.2 |
| 240 | 0.3746 | 0.6165 | 37.8 | 0.6082 | 0.3441 | 63.9 |
| 270 | 0.4132 | 0.5779 | 41.7 | 0.6808 | 0.2715 | 71.5 |
| 300 | 0.4535 | 0.5376 | 45.8 | 0.7523 | 0.2 | 79.0 |
| 330 | 0.4889 | 0.5022 | 49.3 | 0.8107 | 0.1416 | 85.1 |
| 360 | 0.5271 | 0.464 | 53.2 | 0.8702 | 0.0821 | 91.4 |
| 390 | 0.5682 | 0.4229 | 57.3 | 0.9177 | 0.0346 | 96.4 |
| 420 | 0.6077 | 0.3834 | 61.3 | 0.944 | 0.0083 | 99.1 |
| 450 | 0.6472 | 0.3439 | 65.3 | 0.9478 | 0.0045 | 99.5 |
| 480 | 0.6881 | 0.303 | 69.4 | 0.9496 | 0.0027 | 99.7 |

### Example 5

### Evaporation Test at 70° F.

The evaporation test of example 2 was repeated at 70° F. In this experiment the slit were pierced. A control plate having no cover was also monitored in parallel with the sealed plate.

| | Covered Plate | | | Uncovered Plate | | |
|---|---|---|---|---|---|---|
| | | Weighed | | | Weighed | |
| Time | | mass of | | | mass of | |
| (Min) | Loss | water (g) | % Loss | Loss | water (g) | % Loss |
| 0 | 0 | 0.9581 | 0.0 | 0 | 0.9672 | |
| 30 | 0.0344 | 0.9237 | 3.6 | 0.0989 | 0.8683 | 10.2 |
| 60 | 0.0911 | 0.867 | 9.5 | 0.1937 | 0.7735 | 20.0 |
| 90 | 0.1372 | 0.8209 | 14.3 | 0.2892 | 0.678 | 29.9 |
| 120 | 0.1803 | 0.7778 | 18.8 | 0.3756 | 0.5916 | 38.8 |
| 150 | 0.2217 | 0.7364 | 23.1 | 0.4571 | 0.5101 | 47.3 |
| 180 | 0.2661 | 0.692 | 27.8 | 0.5398 | 0.4274 | 55.8 |
| 210 | 0.3125 | 0.6456 | 32.6 | 0.6254 | 0.3418 | 64.7 |
| 240 | 0.3558 | 0.6023 | 37.1 | 0.7061 | 0.2611 | 73.0 |
| 270 | 0.403 | 0.5551 | 42.1 | 0.7847 | 0.1825 | 81.1 |
| 300 | 0.4491 | 0.509 | 46.9 | 0.8567 | 0.1105 | 88.6 |
| 330 | 0.4931 | 0.465 | 51.5 | 0.9167 | 0.0505 | 94.8 |
| 360 | 0.5374 | 0.4207 | 56.1 | 0.9557 | 0.0115 | 98.8 |
| 390 | 0.5826 | 0.3755 | 60.8 | 0.9662 | 0.001 | 99.9 |
| 420 | 0.6244 | 0.3337 | 65.2 | 0.9672 | 0 | 100.0 |
| 450 | 0.6697 | 0.2884 | 69.9 | 0.9672 | 0 | 100.0 |
| 480 | 0.7101 | 0.248 | 74.1 | 0.9672 | 0 | 100.0 |

### Example 6

### Evaporation Test at 31° C.

The evaporation test of example 2 was repeated at 31° C. (in an oven) with a slitted cover on the plate and also on a control plate with no cover. 10 μL of water was pipetted into each of the 96 wells. A box was put over the plates in order to prevent the oven fan from blowing directly over the plates.

| | Covered Plate | | | Uncovered Plate | | |
|---|---|---|---|---|---|---|
| | | Weighed | | | Weighed | |
| Time | | mass of | | | mass of | |
| (Min) | Loss | water (g) | % Loss | Loss | water (g) | % Loss |
| 0 | 0 | 0.9708 | 0.0 | 0 | 0.9614 | |
| 30 | 0.0822 | 0.8886 | 8.5 | 0.1503 | 0.8111 | 15.6 |
| 60 | 0.2101 | 0.7607 | 21.6 | 0.3525 | 0.6089 | 36.7 |
| 90 | 0.3238 | 0.647 | 33.4 | 0.5215 | 0.4399 | 54.2 |
| 120 | 0.4166 | 0.5542 | 42.9 | 0.6898 | 0.2716 | 71.7 |
| 150 | 0.518 | 0.4528 | 53.4 | 0.8452 | 0.1162 | 87.9 |
| 180 | 0.6093 | 0.3615 | 62.8 | 0.9515 | 0.0099 | 99.0 |
| 210 | 0.6948 | 0.276 | 71.6 | 0 | 0.9614 | 0.0 |
| 240 | 0.778 | 0.1928 | 80.1 | 0 | 0.9614 | 0.0 |
| 270 | 0.8439 | 0.1269 | 86.9 | 0 | 0.9614 | 0.0 |
| 300 | 0.8976 | 0.0732 | 92.5 | 0 | 0.9614 | 0.0 |
| 330 | 0.9408 | 0.03 | 96.9 | 0 | 0.9614 | 0.0 |
| 360 | 0.9629 | 0.0079 | 99.2 | 0 | 0.9614 | 0.0 |
| 390 | 0 | 0.9708 | 0.0 | 0 | 0.9614 | 0.0 |
| 420 | 0 | 0.9708 | 0.0 | 0 | 0.9614 | 0.0 |
| 450 | 0 | 0.9708 | 0.0 | 0 | 0.9614 | 0.0 |
| 480 | 0 | 0.9708 | 0.0 | 0 | 0.9614 | 0.0 |

### Example 7

### Evaporation Test at 31° C.

The evaporation test of example 6 was repeated.

| | Covered Plate | | | Uncovered Plate | | |
|---|---|---|---|---|---|---|
| | | Weighed | | | Weighed | |
| Time | | mass of | | | mass of | |
| (Min) | Loss | water (g) | % Loss | Loss | water (g) | % Loss |
| 0 | 0 | 0.9534 | 0.0 | 0 | 0.9632 | |
| 30 | 0.0848 | 0.8686 | 8.9 | 0.1485 | 0.8147 | 15.4 |
| 60 | 0.1652 | 0.7882 | 17.3 | 0.3016 | 0.6616 | 31.3 |
| 90 | 0.2496 | 0.7038 | 26.2 | 0.4623 | 0.5009 | 48.0 |
| 120 | 0.335 | 0.6184 | 35.1 | 0.615 | 0.3482 | 63.8 |
| 150 | 0.4121 | 0.5413 | 43.2 | 0.7556 | 0.2076 | 78.4 |
| 180 | 0.501 | 0.4524 | 52.5 | 0.8865 | 0.0767 | 92.0 |
| 210 | 0.5885 | 0.3649 | 61.7 | 0.9635 | −0.0003 | 100.0 |
| 240 | 0.6703 | 0.2831 | 70.3 | 0 | 0.9632 | 0.0 |
| 270 | 0.7485 | 0.2049 | 78.5 | 0 | 0.9632 | 0.0 |
| 300 | 0.8232 | 0.1302 | 86.3 | 0 | 0.9632 | 0.0 |
| 330 | 0.8881 | 0.0653 | 93.2 | 0 | 0.9632 | 0.0 |
| 360 | 0.9326 | 0.0208 | 97.8 | 0 | 0.9632 | 0.0 |
| 390 | 0.9523 | 0.0011 | 99.9 | 0 | 0.9632 | 0.0 |
| 420 | 0 | 0.9534 | 0.0 | 0 | 0.9632 | 0.0 |
| 450 | 0 | 0.9534 | 0.0 | 0 | 0.9632 | 0.0 |
| 480 | 0 | 0.9534 | 0.0 | 0 | 0.9632 | 0.0 |

### Example 8

### Evaporation Test at 31° C.

The evaporation test of example 6 was repeated, however, in this iteration 20 μL of water was pipetted into each of the 96 wells.

| | Covered Plate | | | Uncovered Plate | | |
|---|---|---|---|---|---|---|
| | | Weighed | | | Weighed | |
| Time | | mass of | | | mass of | |
| (Min) | Loss | water (g) | % Loss | Loss | water (g) | % Loss |
| 0 | 0 | 1.9135 | 0.0 | 0 | 1.908 | |
| 30 | 0.0655 | 1.848 | 3.4 | 0.1565 | 1.7515 | 8.2 |
| 60 | 0.1421 | 1.7714 | 7.4 | 0.3211 | 1.5869 | 16.8 |
| 90 | 0.2235 | 1.69 | 11.7 | 0.4833 | 1.4247 | 25.3 |
| 120 | 0.3085 | 1.605 | 16.1 | 0.6475 | 1.2605 | 33.9 |
| 150 | 0.3959 | 1.5176 | 20.7 | 0.8223 | 1.0857 | 43.1 |
| 180 | 0.4589 | 1.4546 | 24.0 | 0.9877 | 0.9203 | 51.8 |
| 210 | 0.5641 | 1.3494 | 29.5 | 1.1358 | 0.7722 | 59.5 |
| 240 | 0.672 | 1.2415 | 35.1 | 1.3349 | 0.5731 | 70.0 |
| 270 | 0.7598 | 1.1537 | 39.7 | 1.4859 | 0.4221 | 77.9 |
| 300 | 0.8245 | 1.089 | 43.1 | 1.6103 | 0.2977 | 84.4 |
| 330 | 0.9211 | 0.9924 | 48.1 | 1.7396 | 0.1684 | 91.2 |
| 360 | 1.0073 | 0.9062 | 52.6 | 1.8472 | 0.0608 | 96.8 |
| 390 | 1.0915 | 0.822 | 57.0 | 1.9043 | 0.0037 | 99.8 |
| 420 | 1.1795 | 0.734 | 61.6 | 1.9099 | −0.0019 | 100.1 |
| 450 | 1.262 | 0.6515 | 66.0 | 0 | 1.908 | 0.0 |
| 480 | 1.3236 | 0.5899 | 69.2 | 0 | 1.908 | 0.0 |

### Example 9

### Evaporation Test

V bottom, polypropylene 96 well plates (Corning Part Number 3363, VWR part number 2944102) were used in this experiment. The weight of a partial plate (approximately 20 wells) was determined. Then 15 μL of water was pipetted into each of 12 wells and the total weight measurement was taken again. The weight was measured at 15 minute intervals over the course of the experiment. The loss of weight was divided by 12 to measure an average evaporative loss over the 12 wells. All wells were open except for one experiment. In this experiment, a clear thin plastic sealing tape was attached to the partial plate after the water was pipetted into the plate. The each well was slit with a razor blade so that the slit extended to each end of the well.

The results show that refrigeration resulted in the smallest losses and a covered, slit well had the next lowest losses. Losses under a hood (moving air) were quite rapid.

Liquid Open Air at 20° C.

| Time | Volume |
|---|---|
| (min) | (μL) |
| 0 | 15.15 |
| 15 | 14.50 |
| 30 | 13.96 |
| 45 | 13.37 |
| 60 | 12.86 |
| 75 | 12.33 |
| 90 | 11.82 |
| 105 | 11.32 |
| 120 | 10.70 |
| 135 | 10.16 |
| 150 | 9.60 |
| 165 | 9.11 |
| 180 | 8.58 |
| 195 | 8.02 |
| 210 | 7.49 |
| 225 | 6.97 |
| 240 | 6.54 |
| 255 | 5.91 |
| 270 | 5.29 |
| 285 | 4.80 |
| 300 | 4.35 |
| 315 | 3.89 |
| 330 | 3.23 |
| 345 | 1.89 |
| 360 | 1.60 |
| 375 | 0.55 |
| 390 | 0.55 |
| 405 | 0.13 |
| 420 | 0.02 |
| 435 | 0.01 |

Liquid in Open Refrigerator at 8° C.

| Time | Volume |
|---|---|
| (min) | (μL) |
| 0 | 15.21 |
| 15 | 15.33 |
| 30 | 15.21 |
| 45 | 15.15 |
| 60 | 15.03 |
| 75 | 14.89 |
| 90 | 14.79 |
| 105 | 14.12 |
| 120 | 14.26 |
| 135 | 14.38 |
| 150 | 14.03 |
| 165 | 13.88 |
| 180 | 13.81 |
| 195 | 13.68 |
| 210 | 13.89 |
| 225 | 13.58 |
| 240 | 13.48 |
| 255 | 13.18 |
| 270 | 13.10 |
| 285 | 12.90 |
| 300 | 12.71 |

Liquid in Hood at 20° C.

| Time | Volume |
|---|---|
| (min) | (μL) |
| 0 | 15.23 |
| 15 | 14.52 |
| 30 | 13.71 |
| 45 | 12.81 |
| 60 | 11.68 |
| 75 | 10.65 |
| 90 | 9.66 |
| 105 | 8.81 |
| 120 | 7.86 |
| 135 | 6.57 |
| 150 | 4.20 |
| 165 | 3.72 |
| 180 | 2.77 |
| 195 | 1.82 |
| 210 | 0.98 |
| 225 | 0.44 |
| 240 | 0.07 |
| 255 | 0.07 |

Liquid Covered with Slit Sealing Tape

| Time | Volume |
|---|---|
| (min) | (μL) |
| 0 | 15.19 |
| 15 | 14.82 |
| 30 | 14.48 |
| 45 | 14.22 |
| 60 | 13.86 |
| 75 | 13.50 |
| 90 | 13.21 |
| 105 | 12.92 |
| 120 | 12.63 |
| 135 | 12.20 |
| 150 | 11.33 |
| 165 | 11.13 |
| 180 | 10.75 |
| 195 | 10.35 |
| 210 | 9.96 |
| 225 | 9.58 |
| 240 | 9.17 |
| 255 | 8.38 |
| 270 | 8.16 |
| 285 | 7.82 |
| 300 | 7.22 |

While the invention has been described in connection with specific embodiments thereof, it will be understood that it is capable of further modifications and this application is intended to cover and variations, uses, or adaptations of the invention that follow, in general, the principles of the invention, including such departures from the present disclosure as come within known or customary practice within the art to which the invention pertains and as may be applied to the essential features hereinbefore set forth. Moreover, the fact that certain aspects of the invention are pointed out as preferred embodiments is not intended to in any way limit the invention to such preferred embodiments.

What is claimed is:

1. A microplate cover seal comprising:
a) a film having a lower face and a plurality of slits, wherein the position of each slit corresponds to the position of a well on a microplate; and
b) an adhesive on the lower face,
wherein when the film is operatively affixed to a corresponding microplate, the film has sufficient pliability that the output end of a liquid handling device attached to a pump can penetrate the slit;
wherein after the liquid handling device is retracted from the slit, the film has sufficient memory such that the slit substantially reverts to its conformation prior to penetration of the liquid handling device; and
wherein the film does not exert sufficient frictional force to disconnect the liquid handling device from the pump.

2. The microplate cover seal of claim 1, wherein when the cover seal is operatively affixed to a corresponding microplate, evaporation of a liquid from a well on the plate is substantially attenuated.

3. The microplate cover seal of claim 1, wherein when the cover seal is operatively affixed to a corresponding microplate, evaporation of a liquid from a well on the plate is attenuated to less than 60% of the evaporation rate from the corresponding microplate when uncovered.

4. The microplate cover seal of claim 1, wherein when the cover seal operatively affixed to a corresponding microplate, evaporation of a liquid from a well on the plate is attenuated to less than 30% of the evaporation rate from the corresponding microplate when uncovered.

5. The microplate cover seal of claim 1, wherein when the cover seal is operatively affixed to a corresponding microplate, the slit is able to accommodate a liquid handling device having an effective diameter in the range of 0.1 mm to 9 mm.

6. The microplate cover seal of claim 1, wherein when the cover seal is operatively affixed to a corresponding microplate, the slit is able to accommodate a liquid handling device having an effective diameter 50% that of a corresponding well of the microplate.

7. The microplate cover seal of claim 1, wherein the film comprises polyester.

8. The microplate cover seal of claim 1, wherein the film comprises polyethylene terephthalate.

9. The microplate cover seal of claim 1, wherein the slit is a U-cut.

10. The microplate cover seal of claim 1, wherein the slit is a straight cut.

11. The microplate cover seal of claim 1, wherein the slit is a cross-cut

12. The microplate cover seal of claim 1, wherein the slit does not bind to a liquid handling device having and effective diameter between 0.1 and 9 mm diameter accommodated within the slit.

13. The microplate cover seal of claim 1, wherein the adhesive comprises silicone.

14. The microplate cover seal of claim 1, wherein the adhesive comprises acrylic.

15. The microplate cover seal of claim 1, wherein the film is optically clear.

16. A sealed microplate comprising:
a) a microplate cover seal of claim 1; and
b) a corresponding microplate, wherein the microplate cover seal is operatively affixed to the corresponding microplate.
